(19) United States
(12) Patent Application Publication
(10) Pub. No.: US 2010/0325205 A1
(43) Pub. Date: Dec. 23, 2010

(54) EVENT RECOMMENDATION SERVICE

(75) Inventors: Shawn M. Murphy, Seattle, WA (US); Scott Jensen, Bellevue, WA (US); Christopher B. Weare, Bellevue, WA (US); Christopher A. Evans, Sammamish, WA (US); Chad C. Gibson, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/486,580

(22) Filed: Jun. 17, 2009

(51) Int. Cl. G06F 15/16; G06F 17/30

(52) U.S. Cl. 709/204; 709/206; 707/769; 707/759; 707/912; 707/955

(57) ABSTRACT

An event recommendation service is described. In embodiments, selection data that correlates to media content selected by a user, location data that corresponds to a location of the user, and event data is received. A recommendation for an event that the user is likely to attend and that is proximate the location of the user can be generated by aggregating the selection data, the location data, and the event data. The recommendation can then be communicated to a user device as a calendar entry, an email message, a text message, and/or an html page for display to inform the user of the event.

### BACKGROUND

A variety of different events, such as concerts, sporting events, and movies, are scheduled to occur every day. People often miss an opportunity to attend an event that they may have liked simply because they are unaware that the event is scheduled. Similarly, some people may miss out on events that they would like because they have never heard of, or are not familiar with, the performers in the event. For example, a person may like a particular country music artist and, a new artist who plays a similar style of country music, is scheduled to perform a concert near where the person lives. The person would most likely enjoy the concert, based on the fact they like music by a similar artist, but may have never heard of the new artist. Furthermore, some people may be aware of an event scheduled nearby that they would like to see, but will not go to the event because they do not know of any friends who also want to attend the event, or have made plans to attend the event.

### SUMMARY

This summary is provided to introduce simplified concepts of an event recommendation service. The simplified concepts are further described below in the Detailed Description. This summary is not intended to identify essential features of the claimed subject matter, nor is it intended for use in determining the scope of the claimed subject matter.

An event recommendation service is described. In embodiments, selection data that correlates to media content selected by a user, location data that corresponds to a location of the user, and event data is received. A recommendation for an event that the user is likely to attend and that is proximate the location of the user can be generated by aggregating the selection data, the location data, and the event data. The recommendation can then be communicated to a user device as a calendar entry, an email message, a text message, and/or an html page for display to inform the user of the event.

In other embodiments, a list of persons known to the user and that are likely to attend the event and/or are scheduled to attend the event can also be generated and communicated to the user device. A selection of a person known to the user and that is likely to attend the event can be received, and an invitation to the event can then be communicated to the person.

### BRIEF DESCRIPTION OF THE DRAWINGS

Embodiments of an event recommendation service are described with reference to the following drawings. The same numbers are used throughout the drawings to reference like features and components:

FIG. 1 illustrates an example system in which embodiments of an event recommendation service can be implemented.

FIG. 2 illustrates an example recommendation for an event displayed at a user device.

FIG. 3 illustrates example method(s) for an event recommendation service in accordance with one or more embodiments.

FIG. 4 illustrates example method(s) for an event recommendation service in accordance with one or more embodiments.

FIG. 5 illustrates various components of an example device that can implement embodiments of an event recommendation service.

### DETAILED DESCRIPTION

Embodiments of an event recommendation service provide a user with recommendations to events, such as concerts and sporting events, that are scheduled nearby where the user lives or is visiting, and that are likely to be of interest to the user. A service layer receives selection data that correlates to media content selected by a user, location data that corresponds to a location of the user, and event data. An event recommendation service can then generate a recommendation for an event that the user is likely to attend and that is proximate the location of the user by aggregating the selection data, the location data, and/or the event data. For example, a recommendation can be generated for a concert by a particular band that is scheduled to occur in Seattle, Wash., based on selection data that indicates the particular band may be a favorite of the user, and based on location data that indicates the user is visiting or lives in Seattle, Wash.

In addition to a recommendation, a list of persons known to the user that are likely to attend the event given their interests and/or are already scheduled to attend the event can also be generated. The list can be used to quickly and easily find friends that are already scheduled to attend the event and to automatically invite friends that would like to attend the event. In an implementation, the event recommendation service can send an invitation to a person automatically or responsive to receiving a selection of the person by the user, such as when initiated from a user device. Alternatively or in addition, the user device can be implemented to automatically send the invitation to the person or responsive to receiving a selection of the person by the user.

While features and concepts of the described systems and methods for an event recommendation service can be implemented in any number of different environments, systems, and/or various configurations, embodiments of an event recommendation service are described in the context of the following example systems and environments.

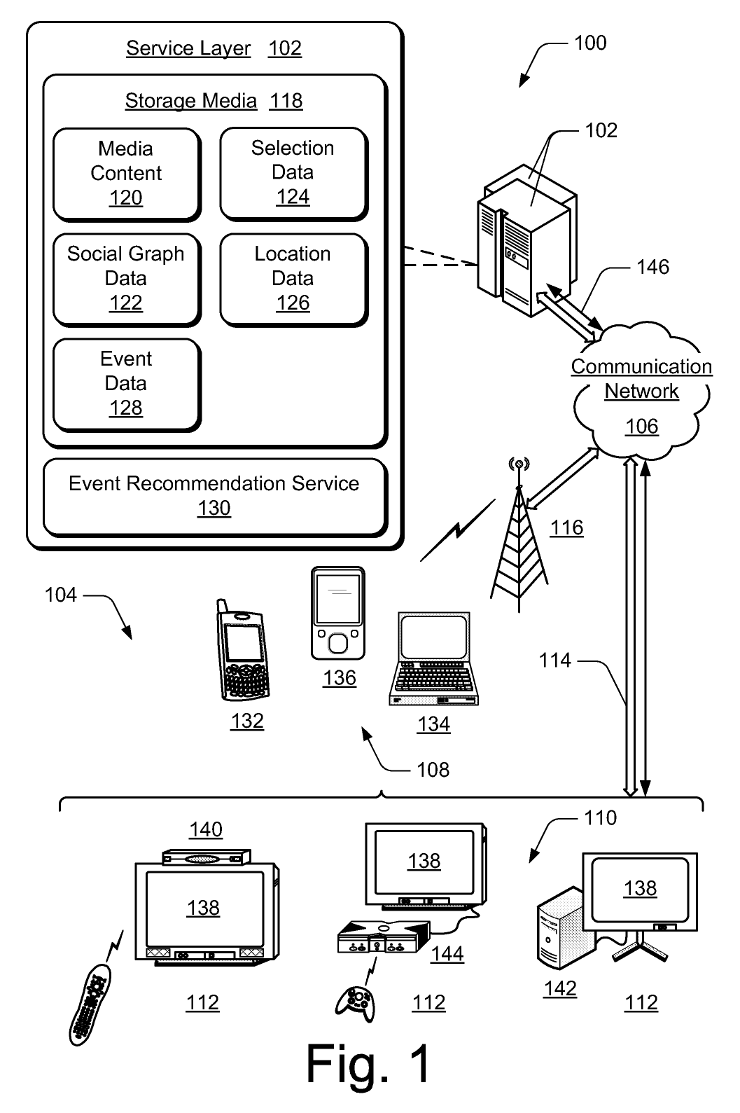

FIG. 1 illustrates an example system 100 in which various embodiments of an event recommendation service can be implemented. In this example, system 100 includes a service layer 102 that can be configured to communicate or otherwise provide media content and data to any number of various user devices 104 via a communication network 106. The various user devices 104 can include wireless user devices 108 as well as other client devices 110 (e.g., wired and/or wireless devices) that are implemented as components in various client systems 112 in a media content distribution system.

The communication network 106 can be implemented to include a broadcast network, an IP-based network 114, and/or a wireless network 116 that facilitates media content distribution and data communication between the service layer 102 and any number of the various user devices. The communication network 106 can also be implemented as part of a media content distribution system using any type of network topology and/or communication protocol, and can be represented or otherwise implemented as a combination of two or more networks.

In the example system 100, service layer 102 includes storage media 118 to store or otherwise maintain various data and media content, such as media content 120, social graph data 122, selection data 124, location data 126, and event data 128. The storage media 118 can be implemented as any type of memory, random access memory (RAM), a nonvolatile memory such as flash memory, read only memory (ROM), and/or other suitable electronic data storage. Service layer 102 can also include one or more media content servers that are implemented to communicate, or otherwise distribute, the media content 120 and/or other data to any number of the various user devices.

The media content 120 can include any type of audio, video, and/or image data received from any type of media content or data source. As described throughout, “media content” can include music, television programming, movies, on-demand media content, interactive games, network-based applications, and any other audio, video, and/or image data. The media content 120 can also include usage data for other types of activities. For example, if a user plays sports and it was known how frequently or the personal baseball stats over a season, then sporting events can be recommended based on players with similar playing styles to the user. Likewise book author talks can be recommended if a reading or library history is known about the user.

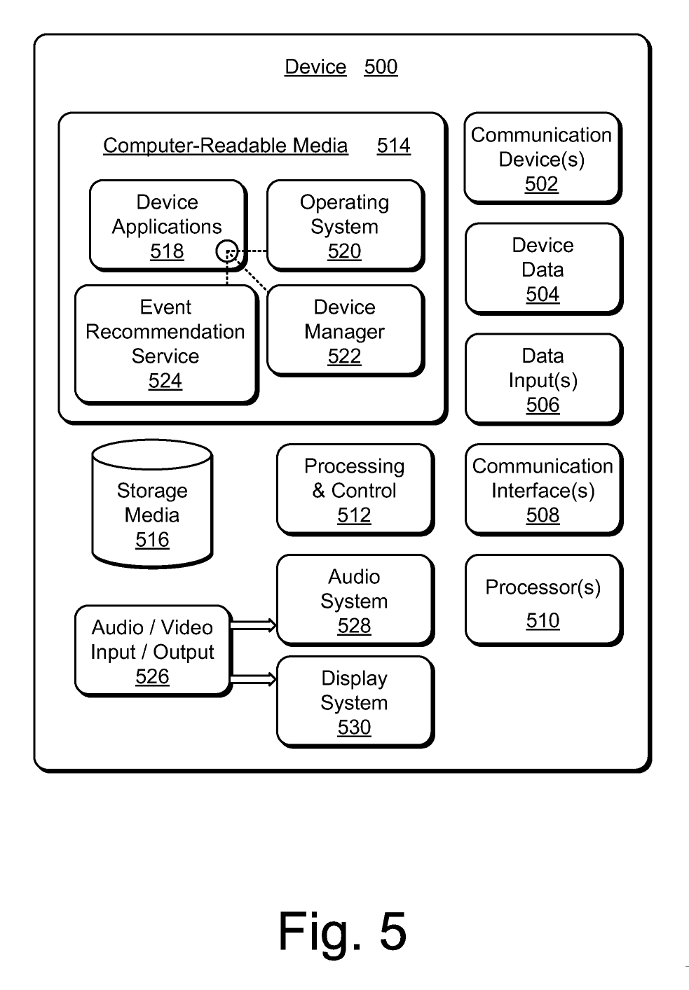

Service layer 102 also includes an event recommendation service 130 that can be implemented as computer-executable instructions and executed by processors to implement the various embodiments and/or features described herein. In addition, service layer 102 can be implemented with any number and combination of differing components as further described with reference to the example device shown in FIG. 5. The event recommendation service 130, as well as other functionality described to implement embodiments of an event recommendation service, can also be provided as a service apart from the service layer 102 (e.g., on a separate server or by a third party service).

The wireless user devices 108 can include any type of device implemented to receive and/or communicate wireless data, such as any one or combination of a mobile phone 132 (e.g., cellular, VoIP, WiFi, etc.), a portable computer device 134, a media device 136 (e.g., a personal media player, portable media player, etc.), and/or any other wireless user device that can receive media content in any form of audio, video, and/or image data. Each of the client systems 112 include a respective client device and display device 138 that together render or playback any form of audio, video, and/or image media content.

A display device 138 can be implemented as any type of a television, high definition television (HDTV), LCD, or similar display system. A client device in a client system 112 can be implemented as any one or combination of a television client device 140 (e.g., a television set-top box, a digital video recorder (DVR), etc.), a computer device 142, a gaming system 144, an appliance device, an electronic device, and/or as any other type of client device that may be implemented to receive media content in any form of audio, video, and/or image data in a media content distribution system.

Any of the user devices can be implemented with one or more processors, communication components, memory components, signal processing and control circuits, and a media content rendering system. Further, any of the wireless user devices 108 and/or other client devices 110 can be implemented with any number and combination of differing components as further described with reference to the example device shown in FIG. 5. A user device may also be associated with a user (i.e., a person) and/or an entity that operates the device such that a user device describes logical devices that include users, software, and/or a combination of devices.

Any of the wireless user devices 108 and/or other client devices 110 can communicate with service layer 102 via a two-way data communication link 146 of the communication network 106. It is contemplated that any one or more of the arrowed communication link 146, IP-based network 114, and wireless network 116, along with communication network 106, facilitate two-way data communication, such as from a user device to the service layer 102 and vice-versa.

The service layer 102 can receive and store the selection data 124, location data 126, and event data 128 when received from any of the user devices 104 via communication network 106. Selection data 124 (e.g., usage data, play data, and the like) correlates to media content selected, downloaded, played, and/or rendered when initiated by a user, and the location data 126 corresponds to a location of the user. Event data 128 includes date, time, and/or location information corresponding to scheduled events, such as concerts, sporting events, conferences, and the like. The event recommendation service 130 is implemented to generate a recommendation for an event that a user would likely want to attend and that is proximate the location of the user by aggregating the selection data 124, location data 126, and event data 128.

The selection data 124 correlates to media content that has been selected by a user and/or user interactions with the selected media content via any of the various user devices. The event recommendation service 130 can determine media content that users like and/or may like based on the selection data, which can include catalog data, usage data, ratings data, and/or similarity data.

Catalog data includes a listing of available media content 120. Catalog data may also include a listing of media content or an asset that is downloaded, purchased, stored, and/or owned by a user. For example, a user may own a variety of different songs and videos that are stored on portable media device 136. In this example, a listing of the songs and videos stored on the portable media device can be communicated to the service layer 102 as catalog data. Further, when a new song or video is added to the portable media device, the catalog data associated with the new song or video can be received by service layer 102 to update the catalog data that is associated with the user.

Based on the catalog data, the event recommendation service 130 can determine media content that the user likes and/or may like. For example, if a user device contains nearly every album by a particular artist, the event recommendation service 130 can determine that a user likes music by the artist. Similarly, if a user has purchased several movies starring a particular actor, the event recommendation service can determine that the user may also like other movies starring the actor.

Usage data indicates the number of times and/or frequency that a user has rendered or played media content that is identified by the catalog data associated with the user. For example the usage data can indicate that a particular song has been played hundreds of times on portable media device 136, or that movies starring a particular actor are frequently displayed for viewing at the portable media device. When a user plays or renders media content, usage data can be received by the service layer 102 from the portable media device 136 via communication network 106. The event recommendation service 130 can then determine media content that the user likes and/or may like based on the number of times and/or the frequency that the user has rendered and/or played media content.

Ratings data includes ratings that have been assigned to media content by the user or other users. For example, the user can assign ratings to songs or movies on portable media device 136 to indicate how much the user likes a particular song or movie. When the user assigns a rating to media content, ratings data can be received by the service layer 102 from the portable media device. The event recommendation service 130 can then determine types of media content that the user likes and/or may like based on media content that has been assigned a high ranking by the user.

Similarity data indicates similar media content that a user is likely to enjoy based on the catalog data, usage data, and/or ratings data that is associated with a user. Media content or an asset can be assigned a rating, such as between 0.0 and 1.0, or assigned a rating in any other rating range. In this example, a rating of 0.0 indicates that there is no similarity between a media asset and the catalog, usage, and/or ratings data that is associated with a user. A rating of 1.0 indicates that the media asset is already identified by the catalog, usage, and/or ratings data that is associated with the user. For example, service layer 102 may receive similarity data indicating that a user is likely to enjoy music by a particular country music artist based on the fact that the user played songs by a related country musician on portable media device 136.

The similarity data can also be used to identify persons that have similar catalog, usage, and/or ratings data as the user. Service layer 102 can receive catalog, usage, and/or ratings data from a variety of different users via the various user devices, and a similarity rating can be assigned between users to indicate the similarity between catalog, usage, and/or ratings data of users. For example, users that have similar catalog, usage, and/or ratings data can have a high similarity rating (e.g., closer to 1.0) whereas users whose catalog, usage, and/or ratings data has very little similarity have a low similarity rating (e.g., closer to 0.0). The event recommendation service 130 can predict that a user will like media content that is liked by other users who are similar to the user, as indicated by the catalog, usage, and/or ratings data.

Location data 126 includes data that indicates the location of a user at a particular time and/or date. Location data 126 can be derived in a variety of different ways. For instance, the location of a user can be determined from a location entered by the user (e.g. a current city, state, and/or zip code) into a user device 104. Location data can also be determined from a location included in a calendar entry. For example, a calendar entry may indicate that the user will be in Portland, Oreg. on May 28, 2009 for a business conference and the event recommendation service 130 can determine the location of the user on the particular date. Location data can also be determined automatically, such as by a GPS system integrated with a user device 104 that can determine a real time location of the user. It should be noted that there are a variety of ways in which the location of a user can be determined.

Event data 128 includes data that indicates a date, time, and/or location of a scheduled event. For example, event data can indicate that an event is scheduled for May 28, 2009 at 7:00 p.m. in Portland, Oreg. As described herein, an event can refer to virtually any scheduled occasion. Examples of events include, but are not limited to, concerts, sporting events, movies, plays, musicals, comedy shows, and conferences. Event data 128 can be received by service layer 102 from a variety of different sources including, but not limited to, concert venues, listings of scheduled concerts, event listing services, movie ticket services, and from specific artists, musicians, or sports teams. For example, a server associated with a concert venue may communicate a listing of all upcoming concerts at the concert venue to service layer 102.

In various embodiments, the event recommendation service 130 at service layer 102 is implemented to generate a recommendation for an event that the user is likely to attend and that is proximate the location of the user by aggregating the selection data 124, location data 126, and/or event data 128. To generate the recommendation, the event recommendation service can determine events that are scheduled to occur proximate the location of a user by comparing location data 126 associated with the user to the locations of events included in the event data 128. The proximity of events that are considered by the event recommendation service may be a default distance from the location of the user, such as fifty miles or one-hundred miles. In an implementation, the proximity of events that the event recommendation service considers can be defined by the user. For instance, the user can indicate a desire to receive recommendations for events that are within three-hundred miles of the user's location, or that are within the same state as the location of the user. In another implementation, the proximity of events that the event recommendation service considers may vary based on how likely the user is to enjoy the event. For example, if the proximity of events considered is set to fifty miles, the event recommendation service may still consider a concert by the favorite band of a user that is scheduled to occur one-hundred miles from the location of the user.

The event recommendation service 130 can compare the events that are scheduled to occur proximate the location of the user to selection data 124 that is associated with the user. The event recommendation service 130 can determine the similarity between an event and the selection data that is associated with the user, noting that in many instances the selection data correlates to events. For example, selection data associated with music can be used to predict concerts that a user would be inclined to attend. Similarly, selection data associated with movies played on a user device can be used to predict movies that a user would be inclined to watch at a movie theatre. The correlation between selection data and events, however, is not only limited to music and movies. For example, selection data indicating that a user plays a football video game could be used to predict that a user would like to attend a football game. The selection data can also be associated with events that the user has already attended. For example, the fact that a user attended a concert by a particular artist in the past could be used to predict that the user would like to attend a concert by the same artist again.

Accordingly, if the selection data that is associated with the user indicates that the user is likely to attend one of the events proximate the location of the user based on a high similarity between the event and the selection data, then the event recommendation service 130 can generate a recommendation for the event. For example, the service layer 102 can receive selection data 124 indicating that a user likes the music of a particular rock group, and the selection data that is associated with the user may indicate that the user has downloaded all of the music and/or has played songs by the particular rock group many times on a portable media device. Alternatively or in addition, the user may have assigned a high rating to many of the songs by the particular rock group. The service layer 102 can also receive location data 126 from a calendar that indicates the user will be in Seattle, Wash. on Friday, May 15, 2009 for a business meeting. In addition, the service layer 102 can also receive event data 128 that indicates the particular rock group will be performing at a concert venue in Seattle on the same Friday. The event recommendation service 130 can then generate a recommendation for the user to attend the concert at the concert venue in Seattle, Wash. on Friday, May 15, 2009 by aggregating the selection data 124, location data 126, and event data 128 that is all associated with the user.

It is to be appreciated that the level of similarity between the selection data that is associated with the user and an event from which a recommendation is generated can vary. For example, a user that has every album by a particular artist would most likely be interested in attending a concert by the artist. On the other hand, a user that has played a song by a particular artist five times may be only mildly interested in attending a concert by the artist. In some embodiments, the level of similarity that is evaluated or determined to generate a recommendation for an event can be modified by the user. For example, the user could indicate an interest in only receiving recommendations to concerts if the user has two or more albums, or a defined number of songs, by the artist or band performing.

In various embodiments, the event recommendation service 130 can be implemented to generate a list of persons known to the user that are scheduled to attend an event and/or that are likely to attend the event. Social graph data 122 includes a list of persons known to the user and the relationships between the user and the persons known to the user (e.g., friends of the user and/or family members of the user). The service layer 102 can receive the selection data 124 and the location data 126 for each of these persons known to the user, as discussed above.

The event recommendation service 130 can then generate event recommendations for the persons known to the user by aggregating the selection data 124, location data 126, and/or event data 128 for each of these persons known to the user. The event recommendation service can also compare the event recommendations for the user to the event recommendations for the persons known to the user. When the event recommendation service determines that a person known to the user is likely to attend an event that the user is also likely to attend, then the event recommendation service can include the person in a list of persons known to the user that are likely to attend the event. If the person is already attending the event, then the event recommendation service can include the person in a list of persons that are already attending the event. Similarly, if a person known to the user is not attending the event, then the event recommendation service can include the person in a list of persons that are not attending the event.

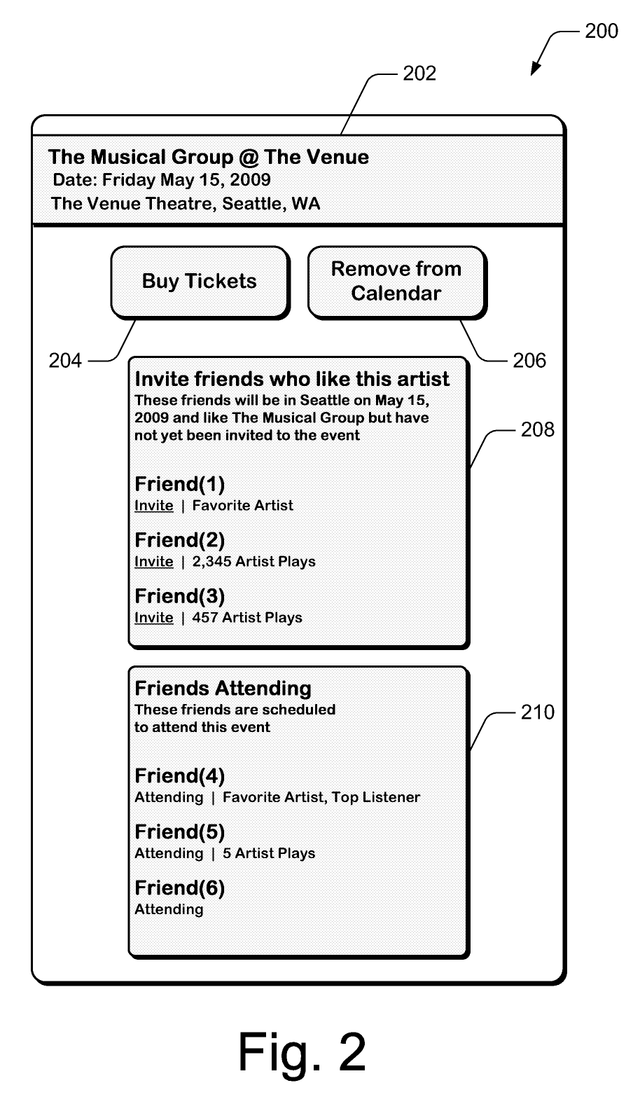

The event recommendation service 130 can initiate communication of a recommendation for an event from service layer 102 to a user device 104 via communication network 106. The recommendation can indicate the name, location, date, and/or time of the event. In addition, the recommendation can include the list of persons known to the user that are scheduled to attend the event and/or that are likely to attend the event. The event recommendation can be communicated to the user device as a calendar entry, an email message, a text message, and/or an html page. An example recommendation for an event is illustrated in FIG. 2, and described in greater detail below.

Although illustrated and described as a component or module of the service layer 102, the event recommendation service 130 can be implemented as an independent service to implement embodiments of an event recommendation service. Further, although the event recommendation service is illustrated and described as a single component or module, the event recommendation service 130 can be implemented as several component applications or modules distributed to implement various embodiments of an event recommendation service as described herein.

FIG. 2 illustrates an example recommendation 200 for an event that can be generated by the event recommendation service 130 as shown in FIG. 1, and received by a user device 104 for display. In various embodiments, the recommendation 200 can be communicated to a user device 104 for display as a calendar entry, an email message, a text message, and/or an html page. Recommendation 200 includes an event information display 202 that includes information about the event, such as the event name, event location, and the event date and time. Recommendation 200 also includes user selectable controls 204 and 206 that can be selected by a user to buy tickets to the event or remove the event from the calendar, respectively. Recommendation 200 also includes an invite display 208 of persons known to the user that are likely to attend the event, and includes a friends display 210 of persons known to the user that are scheduled to attend the event.

In this example, event information display 202 indicates that the recommendation 200 is for a concert by a particular musical group at a concert venue in Seattle, Wash. on May 15, 2009. A user can select the user-selectable control 204 to initiate purchasing tickets to the concert. For example, a selection of control 204 can initiate a buy tickets message to be sent to a server associated with the concert venue that results in the tickets being purchased by the user. Alternatively, a selection of control 204 can initiate a buy tickets message to be sent to the service layer 102 that receives the buy tickets message, and automatically purchase tickets for the user, such as by forwarding the buy tickets message to the server associated with the concert venue.

The invite display 208 is an example of persons known to the user that may be inclined to attend the event. In this example, the persons known to the user are friends. As described above, a list of persons known to the user that are likely to attend the event can be generated by event recommendation service 130. In this example, the event recommendation service has determined that three different friends of the user may be inclined to attend the event if invited or notified of the event. Next to each friend of the user listed in the invite display 208 is a user-selectable invite control that can be selected by the user to automatically invite a friend to the event. When the user selects an invite control, an invitation to the event is automatically sent to the friend. In an embodiment, a selection of an invite control initiates an event invitation message to be sent from the user device directly to the friend. The event invitation message may contain the same or similar information as the example event recommendation 200. In addition, the event invitation message may also indicate that the invitation was sent by the user. In another embodiment, a selection of an invite control initiates an event invitation message to be sent to from the user device to the service layer 102 that receives the event invitation message, and then communicates the event invitation message to the friend.

The invite display 208 can also indicate reasons that the friends are likely to attend the event based on the selection data of the friends. In this example, the event recommendation service 130 has determined that Friend(1) is likely to attend the concert because the musical group has been designated as a favorite band. Similarly, the event recommendation service 130 has determined that Friend(2) and Friend(3) are likely to attend the concert because each has played songs by the musical group many times. In an implementation, the invite display 208 can list the friends that are likely to attend the event in descending order of a likelihood of attendance. In this example, Friend(1) is most likely to attend the event and is listed first because the musical group is a favorite band. Similarly, Friend(2) is more likely to attend the concert than Friend(3) because Friend(2) has played songs by the musical group more times.

The friends display 210 is an example of persons known to the user that are scheduled to attend the event. In this example, a list can be generated by the event recommendation service 130 and include persons known to the user, such as three different friends that are scheduled to attend the concert. As described above, information that indicates reasons the friends are scheduled to attend the event, based on the selection data, is also displayed (e.g., favorite artist, top listener, artist plays).

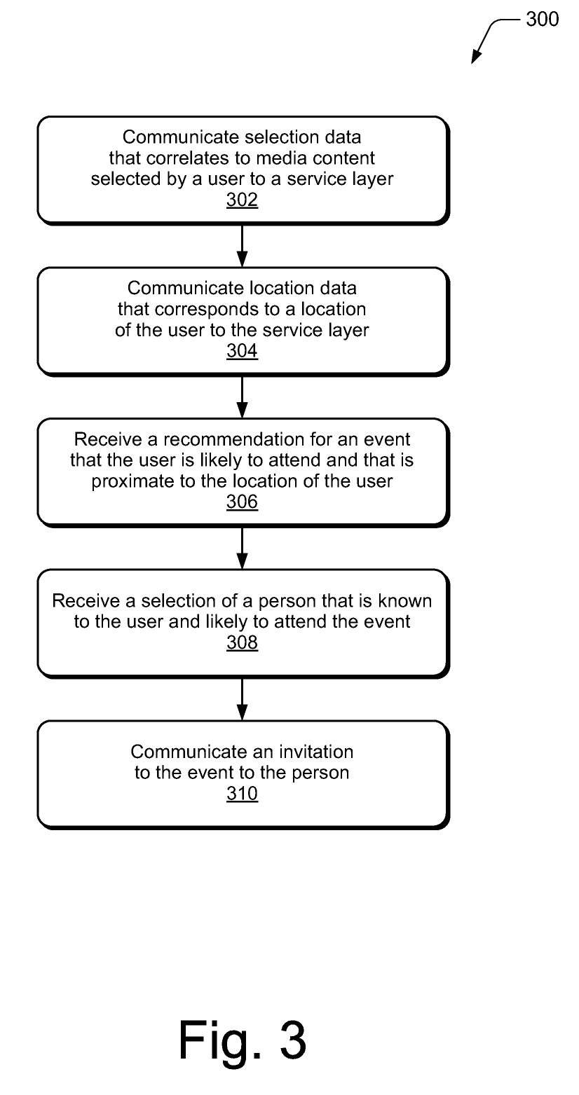

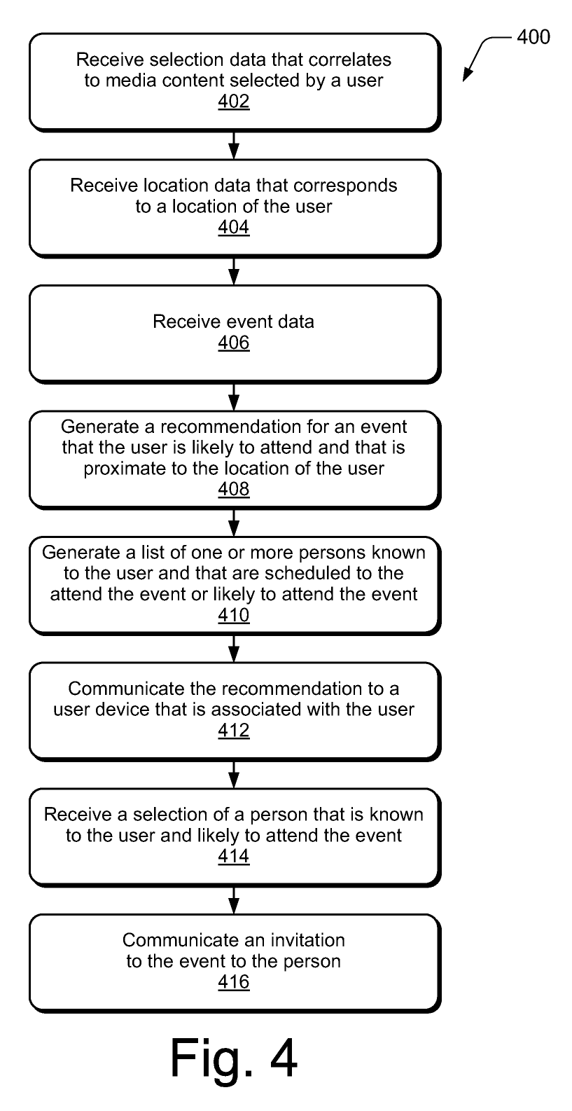

Example methods 300 and 400 are described with reference to respective FIGS. 3 and 4 in accordance with one or more embodiments of an event recommendation service. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example methods may be described in the general context of computer-executable instructions, which can include software, applications, routines, programs, objects, components, data structures, procedures, modules, functions, and the like.

The methods may also be practiced in a distributed computing environment where functions are performed by remote processing devices that are linked through a communication network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 3 illustrates example method(s) 300 of event recommendation service. The order in which the method is described is not intended to be construed as a limitation, and any number of the described method blocks can be combined in any order to implement the method, or an alternate method.

At block 302, selection data that correlates to media content selected by a user is communicated to a service layer. For example, a user device 104 (FIG. 1) communicates selection data 124 to service layer 102 where the selection data correlates to media content that has been selected, downloaded, and/or rendered at a user device by a user. The selection data can include catalog data, usage data, ratings data, and/or similarity data.

At block 304, location data that corresponds to a location of the user is communicated to the service layer. For example, the user device 104 communicates location data 126 that correlates to a location of the user to service layer 102. The location data can include data that indicates the location of a user at a particular time and/or date. In various implementations, the location data is determined from a location entered by the user, a GPS location of the user device that is associated with the user, or a calendar entry of the user.

At block 306, a recommendation for an event that the user is likely to attend and that is proximate the location of the user is received from the service layer. For example, user device 104 receives a recommendation 200 (FIG. 2) for an event from service layer 102. In various embodiments, the recommendation for the event can be received by a user device as a calendar entry, an email message, a text message, and/or an html page for display. The recommendation for the event can include a list of one or more persons known to the user that are likely to attend the event and/or that are scheduled to attend the event. An event invitation can then be sent to a person or friend known to the user that may be inclined to attend the event.

At block 308, a selection is received of a person that is known to the user and likely to attend the event and, at block 310, an invitation to the event is communicated to the person. For example, a user device 104 receives a selection from a user, such as when the user selects a user-selectable invite control from the invite display 208 to initiate an event invitation message being sent to a friend that may be inclined, or is otherwise likely to attend the event. The user device 104 then communicates the event invitation message to a user device that is associated with the friend. Similar to an initial recommendation, the event invitation message can also be communicated as a calendar entry, an email message, a text message, and/or an html page for display.

FIG. 4 illustrates example method(s) 400 of an event recommendation service. The order in which the method is described is not intended to be construed as a limitation, and any number of the described method blocks can be combined in any order to implement the method, or an alternate method.

At block 402, selection data that correlates to media content selected by a user is received. For example, the service layer 102 (FIG. 1) receives selection data 124 from a user device 104 that is associated with a user, and the selection data correlates to media content that has been selected, downloaded, and/or rendered at the user device. The selection data can include catalog data, usage data, ratings data, and/or similarity data.

At block 404, location data that corresponds to a location of the user is received. For example, the service layer 102 receives location data 126 from the user device 104. The location data can include data that indicates the location of a user at a particular time and/or date, and can be determined from a location entered by the user, a GPS location of the user, and/or a calendar entry of the user. At block 406, event data is received. For example, the service layer 102 receives event data 128 from a variety of different sources such as concert venues, listings of scheduled concerts, event listing services, movie ticket services, or from specific artists, musicians, or sports teams. Event data can include data that indicates a date, time, and/or location of a scheduled event.

At block 408, a recommendation for an event that the user is likely to attend and that is proximate the location of the user is generated. For example, the event recommendation service 130 at the service layer 102 generates a recommendation for an event that the user is likely to attend and that is proximate the location of the user by aggregating the selection data 124, location data 126, and/or event data 128. At block 410, a list of one or more persons known to the user and that are scheduled to attend the event or likely to attend the event is generated. For example, the event recommendation service 130 generates a list of one or more persons known to the user and that are scheduled to attend the event and/or likely to attend the event, and that are in geographic proximity to the event at the time of the event. In an implementation, the list of persons is generated from the social graph data 122 that is maintained at the service layer 102. The list of persons known to the user and that are likely to attend the event can also include a list of reasons that each person is likely to attend the event.

At block 412, the recommendation is communicated to a user device that is associated with the user. For example, the service layer 102 communicates the recommendation 200 for an event to a user device 104 that is associated with a user. In various embodiments, the recommendation for the event (e.g., that includes the list of persons) is communicated to the user device as a calendar entry, an email message, a text message, and/or an html page for display.

At block 414, a selection is received of a person that is known to the user and likely to attend the event and, at block 416, an invitation to the event is communicated to the person. For example, the service layer 102 receives a selection from the user device 104, such as when the user selects a user-selectable invite control from the invite display 208 to initiate an event invitation message being sent to a friend that may be inclined, or is otherwise likely to attend the event. The service layer 102 then communicates the event invitation message to a user device that is associated with the friend. Similar to an initial recommendation, the event invitation message can also be communicated as a calendar entry, an email message, a text message, and/or an html page for display.

FIG. 5 illustrates various components of an example device 500 that can be implemented as any type of client device and/or service layer as described with reference to FIG. 1 to implement embodiments of an event recommendation service. In embodiments, device 500 can be implemented as any one or combination of a wired and/or wireless device, as any form of television client device (e.g., television set-top box, digital video recorder (DVR), etc.), consumer device, computer device, portable computer device, user device, communication device, video processing and/or rendering device, appliance device, gaming device, electronic device, and/or as any other type of device. Device 500 may also be associated with a user (i.e., a person) and/or an entity that operates the device such that a device describes logical devices that include users, software, firmware, and/or a combination of devices.

Device 500 includes communication devices 502 that enable wired and/or wireless communication of device data 504 (e.g., received data, data that is being received, data scheduled for broadcast, data packets of the data, etc.). The device data 504 or other device content can include configuration settings of the device, media content stored on the device, and/or information associated with a user of the device. Media content stored on device 500 can include any type of audio, video, and/or image data. Device 500 includes one or more data inputs 506 via which any type of data, media content, and/or inputs can be received, such as user-selectable inputs, messages, music, television media content, recorded video content, and any other type of audio, video, and/or image data received from any content source and/or data source.

Device 500 also includes communication interfaces 508 that can be implemented as any one or more of a serial and/or parallel interface, a wireless interface, any type of network interface, a modem, and as any other type of communication interface. The communication interfaces 508 provide a connection and/or communication links between device 500 and a communication network by which other electronic, computing, and communication devices can communicate data with device 500.

Device 500 can include one or more processors 510 (e.g., any of microprocessors, controllers, and the like) which process various computer-executable instructions to control the operation of device 500 and to implement embodiments of an event recommendation service. Alternatively or in addition, device 500 can be implemented with any one or combination of hardware, firmware, or fixed logic circuitry that is implemented in connection with processing and control circuits which are generally identified at 512. Although not shown, device 500 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 500 can also include computer-readable media 514, such as one or more memory components, examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 500 can also include a mass storage media device 516.

Computer-readable media 514 provides data storage mechanisms to store the device data 504, as well as various device applications 518 and any other types of information and/or data related to operational aspects of device 500. For example, an operating system 520 can be maintained as a computer application with the computer-readable media 514 and executed on processors 510. The device applications 518 can include a device manager 522 (e.g., a control application, soft-ware application, signal processing and control module, code that is native to a particular device, a hardware abstraction layer for a particular device, etc.). The device applications 518 can also include any system components or modules of an event recommendation service 524 to implement the various embodiments of an event recommendation service as described herein. In this example, the device applications 518 are shown as software modules and/or computer applications. Alternatively or in addition, the event recommendation service 524 can be implemented as hardware, software, firmware, or any combination thereof.

Device 500 can also include an audio and/or video input-output system 526 that provides audio data to an audio system 528 and/or provides video data to a display system 530. The audio system 528 and/or the display system 530 can include any devices that process, display, and/or otherwise render audio, video, and image data. Video signals and audio signals can be communicated from device 500 to an audio device and/or to a display device via an RF (radio frequency) link, S-video link, composite video link, component video link, DVI (digital video interface), analog audio connection, or other similar communication link. In an embodiment, audio system 528 and/or the display system 530 can be implemented as external components to device 500. Alternatively, the audio system 528 and/or the display system 530 can be implemented as integrated components of example device 500.

Although embodiments of an event recommendation service have been described in language specific to features and/or methods, it is to be understood that the subject of the appended claims is not necessarily limited to the specific features or methods described. Rather, the specific features and methods are disclosed as example implementations of an event recommendation service.

1. A computer-implemented method, comprising:
communicating selection data that correlates to media content selected by a user to a service layer;
communicating location data that corresponds to a location of the user to the service layer; and
receiving, from the service layer, a recommendation for an event that the user is likely to attend and that is proximate the location of the user, the recommendation being generated based at least on the selection data and the location data.

2. The computer-implemented method as recited in claim 1, wherein the selection data correlates to music that has been rendered or downloaded, and wherein the recommendation is for the event that the user is likely to attend based on user preferences and interaction with the music.

3. The computer-implemented method as recited in claim 1, wherein the recommendation for the event includes a list of one or more persons known to the user and that are scheduled to attend the event.

4. The computer-implemented method as recited in claim 1, wherein the recommendation for the event includes a list of one or more persons known to the user and that are likely to attend the event.

5. The computer-implemented method as recited in claim 4, wherein the list of one or more persons known to the user and that are likely to attend the event includes a list of one or more reasons that each of the persons are likely to attend the event.

6. The computer-implemented method as recited in claim 4, further comprising:
receiving a selection of a person known to the user that is likely to attend the event; and
communicating an invitation to the event to the person.

7. The computer-implemented method as recited in claim 1, wherein the recommendation for the event is received as at least one of a calendar entry, an email message, a text message, or an html page for display.

8. The computer-implemented method as recited in claim 1, wherein the location data is determined from at least one of a location entered by the user, a GPS location of the user, a calendar entry of the user, or a calendar entry of a friend of the user.

9. A computer-implemented method, comprising:
receiving selection data that correlates to media content selected by a user;
receiving location data that corresponds to a location of the user;
receiving event data; and
generating a recommendation for an event that the user is likely to attend and that is proximate the location of the user, the recommendation being generated by aggregating the selection data, the location data, and the event data.

10. The computer-implemented method as recited in claim 9, further comprising communicating the recommendation to a user device as at least one of a calendar entry, an email message, a text message, or an html page for display.

11. The computer-implemented method as recited in claim 9, further comprising generating a list of one or more persons known to the user and that are scheduled to attend the event.

12. The computer-implemented method as recited in claim 9, further comprising generating a list of one or more persons known to the user and that are likely to attend the event.

13. The computer-implemented method as recited in claim 12, further comprising:
receiving a selection of a person known to the user and that is likely to attend the event; and
communicating an invitation to the event to the person.

14. The computer-implemented method as recited in claim 9, wherein the selection data correlates to at least one of music, a video, a television program, a movie, a podcast, or a game that has been rendered or downloaded, and wherein the recommendation is for the event that the user is likely to attend based on the type of media content.

15. A recommendation system, comprising:
a database of user selections;
a database of user locations;
a database of scheduled events; and
an event recommendation service configured to aggregate the user selections, the user locations, and the scheduled events to generate a recommendation for an event that a user is likely to attend.

16. The recommendation system as recited in claim 15, wherein the event recommendation service is further configured to initiate communication of the recommendation to a user device as at least one of a calendar entry, an email message, a text message, or an html page for display.

17. The recommendation system as recited in claim 15, wherein the database of user selections comprises data associated with at least one of music, videos, television programs, movies, podcasts, or games that have been rendered or downloaded, and wherein the database of scheduled events comprises data associated with the scheduled events.

18. The recommendation system as recited in claim 15, wherein the event recommendation service is further configured to generate a list of one or more persons known to the user and that are scheduled to attend the event.

19. The recommendation system as recited in claim 15, wherein the event recommendation service is further configured to generate a list of one or more persons known to the user and that are likely to attend the event.

20. The recommendation system as recited in claim 15, wherein the database of user locations comprises data determined from at least one of a location entered by the user, a GPS location of the user, or a calendar entry of the user.
